(19) United States
(12) Patent Application Publication
(10) Pub. No.: US 2024/0039019 A1
(43) Pub. Date: Feb. 1, 2024

(54) FUEL CELL SYSTEM AND METHOD FOR START CONTROL THEREIN

(71) Applicant: HYUNDAI MOBIS CO., LTD., Seoul (KR)

(72) Inventors: Hye Su LIM, Yongin-si (KR); Sung Kyung CHOI, Yongin-si (KR); Jong Bo WON, Yongin-si (KR)

(73) Assignee: HYUNDAI MOBIS CO., LTD., Seoul (KR)

(21) Appl. No.: 18/227,424

(22) Filed: Jul. 28, 2023

(30) Foreign Application Priority Data
Jul. 29, 2022 (KR) 10-2022-0094758

(51) Int. Cl. H01M 8/04223; H01M 8/04029; H01M 8/04746; H01M 8/04302; H01M 8/04225; H01M 8/0432; H01M 8/04044; H01M 8/04701

(52) U.S. Cl. CPC H01M 8/04268; H01M 8/04029; H01M 8/04768; H01M 8/04302; H01M 8/04225; H01M 8/04358; H01M 8/04044; H01M 8/04723; H01M 2250/20

(57) ABSTRACT

A fuel cell system includes a coolant control valve to switch a flowing path of a coolant passing through a fluid passage connected to a fuel cell stack, and a controller to control a valve opening amount of the coolant control valve while performing a start sequence previously defined, when a condition for normal start of the fuel cell stack is satisfied, and the coolant control valve is formed by integrating a first valve to switch a flowing path of a coolant flowing into a first pump with a second valve to switch a flowing path of a coolant pumped by the first pump.

### CROSS-REFERENCE TO RELATED APPLICATION

This application claims the benefit of priority to Korean Patent Application No. 10-2022-0094758, filed in the Korean Intellectual Property Office on Jul. 29, 2022, the entire contents of which are incorporated herein by reference.

### TECHNICAL FIELD

The present disclosure relates to a fuel cell system and a method for start control therein.

### BACKGROUND

A fuel cell system may generate electrical energy using a fuel cell stack. For example, when hydrogen is used as the fuel of a fuel cell stack, hydrogen may be an alternative for a global environment problem. Accordingly, studies and researches for the fuel cell system have been consecutively performed.

The fuel cell system includes a fuel cell stack which generates electrical energy, a fuel supply which supplies fuel (hydrogen) to the fuel cell stack, an air supply which supplies oxygen in the air serving as an oxidant necessary for electrochemical reactions, and a thermal management system (TMS) which removes reaction heat from the fuel cell stack to discharge the reaction heat of the fuel cell stack to the outside of the system, controls an operating temperature of the fuel cell stack, and performs a water managing function.

The TMS is a type of cooling device which circulates antifreeze, which serves as a coolant, to the fuel cell stack to maintain an appropriate temperature (e.g., 60° C. to 70° C.). The TMS may include a TMS line for circulating the coolant, a reservoir to store the coolant, a pump to circulate the coolant, an ion filter to remove ions, which are contained in the coolant, and a radiator to discharge heat from the coolant to the outside. In addition, the TMS may include a heater to heat the coolant, and an air conditioning unit (for example, a warming heater) to heat and warm an inner part of a device (e.g., a vehicle) including a fuel cell system by using the coolant. The TMS may maintain a temperature suitable for a power electronic part of a vehicle as well as a fuel cell stack.

The TMS stably supplies a coolant by increasing the temperature of the coolant using a heater in cold start, and stably supplies the coolant to a stack and a power electronic part without using a separate heating source, such as a heater, in normal start.

### SUMMARY

The present disclosure has been made to solve the above-mentioned problems occurring in the prior art while advantages achieved by the prior art are maintained intact.

An aspect of the present disclosure provides a fuel cell system, capable of rapidly and easily controlling thermal management components, such as a coolant pump and an integrated coolant control valve, in starting a fuel cell stack, and a method for start control therein.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell system includes a coolant control valve to switch a flowing path of a coolant passing through a fluid passage connected to a fuel cell stack, and a controller to control a valve opening amount of the coolant control valve by performing a start sequence previously defined, when a condition for normal start of the fuel cell stack is satisfied, and the coolant control valve is formed by integrating a first valve to switch a flowing path of a coolant flowing into a first pump with a second valve to switch a flowing path of a coolant pumped by the first pump.

According to an embodiment, the fuel cell system further includes a first temperature sensor to measure a temperature of ambient air, a second temperature sensor to measure a temperature of a coolant at an inlet of the fuel cell stack, a third temperature sensor to measure a coolant temperature in an ion filter to filter an ion of the coolant passing through the fuel cell stack, and a fourth temperature sensor to measure a coolant temperature of the coolant control valve.

According to an embodiment, the controller determines that the condition for the normal start of the fuel cell stack is satisfied, when the temperature of the ambient air, which is measured by the first temperature sensor, is equal to or greater than a first reference temperature, which is preset, or when the coolant temperature at the inlet of the fuel cell stack, which is measured by the second temperature sensor, is equal to or greater than a second reference temperature which is preset.

According to an embodiment, the start sequence includes a first operation for controlling the valve opening amount of the coolant control valve to open a valve connected to a fluid passage passing through the fuel cell stack and close a valve connected to a fluid passage passing through a radiator, a second operation for setting, to a preset minimum value, a Revolution per Minute (RPM) of a second pump to supply a coolant to the first pump and the power electronic part, a third operation for switching a control mode of the coolant control valve to an automatic control mode, when the coolant temperature of the coolant ion filter, which is measured by the third temperature sensor, and the coolant temperature of the coolant control valve, which is measured by the fourth temperature sensor, satisfy a preset condition, a fourth operation for allowing a cooling fan to enter into an operating allowing mode, and a fifth operation for setting an RPM of the first pump to a specific value (w).

According to an embodiment, the coolant control valve includes a first port connected to a second fluid passage passing through a cathode oxygen depletion (COD) heater such that coolant passing through the second fluid passage flows in the first port, a second port connected to a first fluid passage passing through the fuel cell stack such that coolant passing through the first fluid passage flows in the second port, a third port for draining the coolant flowing in the first port through the second fluid passage connected to the first pump through a fifth fluid passage serving as a by-pass fluid passage of a radiator, a fourth port for draining the coolant flowing in the second port, through the first fluid passage connected to the first pump through the fifth fluid passage, and a fifth port for draining the coolant flowing in the second port, through a fourth fluid passage passing through the radiator.

According to an embodiment, the coolant control valve closes a valve of the fifth port connected to the fourth fluid passage to block the coolant flowing into the radiator, and open a valve of the fourth port connected to the fifth fluid passage serving as a by-pass fluid passage, when the first operation of the start sequence is performed.

According to an embodiment, the controller determines that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than the temperature of the ambient air for a specific time or more.

According to an embodiment, the controller determines that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than the coolant temperature at the inlet of the fuel cell stack, for a specific time or more.

According to an embodiment, the controller automatically adjusts the valve opening amount of the coolant control valve such that the coolant temperature of the coolant control valve is maintained in a target temperature range, when the control mode of the coolant control valve is switched to the automatic control mode through the third operation.

According to an embodiment, the specific value (w) refers to an RPM for draining a flow amount of a coolant circulating a coolant circulating path of the fuel cell system once for a time period, based on a target inflowing amount of coolant.

According to an embodiment, the controller operates the fuel cell stack, when the start sequence is terminated.

According to another aspect of the present disclosure, a method for start control in a fuel cell system includes performing a start sequence previously defined, when a condition for normal start of a fuel cell stack is satisfied, controlling a valve opening amount of a coolant control valve to switch a flowing path of a coolant passing through a fluid passage connected to the fuel cell stack, and switching, by the coolant control valve, a flowing path of a coolant, based on the control. The coolant control valve is formed by integrating a first valve to switch a flowing path of a coolant flowing into a first pump with a second valve to switch a flowing path of a coolant pumped by the first pump.

According to an embodiment, the method further includes determining that the condition for the normal start of the fuel cell stack is satisfied, when temperature of ambient air, which is measured by a first temperature sensor, is equal to or greater than a first reference temperature, which is preset, or when a coolant temperature at the inlet of the fuel cell stack, which is measured by a second temperature sensor, is equal to or greater than a second reference temperature which is preset.

According to an embodiment, the performing of the start sequence includes performing a first operation for controlling the valve opening amount of the coolant control valve to open a valve connected to a fluid passage passing through the fuel cell stack and close a valve connected to a fluid passage passing through a radiator, performing a second operation for setting, to a preset minimum value, a Revolution per Minute (RPM) of a second pump to supply a coolant to the first pump and a power electronic part, performing a third operation for switching a control mode of the coolant control valve to an automatic control mode, when a coolant temperature of an ion filter, which is measured by a third temperature sensor, and a coolant temperature of the coolant control valve, which is measured by a fourth temperature sensor, satisfy a preset condition, performing a fourth operation for allowing a cooling fan to enter into an operating allowing mode, and performing a fifth operation for setting an RPM of the first pump to a specific value (w).

According to an embodiment, the performing of the first operation includes closing a valve connected to a fluid passage passing through the radiator and opening a value connected to a by-pass fluid passage of the radiator.

According to an embodiment, the performing of the third operation includes determining that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than the temperature of the ambient air for a specific time or more.

According to an embodiment, the performing of the third operation includes determining that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than a coolant temperature at an inlet of the fuel cell stack, for a specific time period or more.

According to an embodiment, the performing of the third operation includes automatically adjusting the valve opening amount of the coolant control valve such that the coolant temperature of the coolant control valve is maintained in a target temperature range, when a control mode of the coolant control valve is switched to an automatic control mode.

According to an embodiment, the specific value (w) refers to an RPM for draining a flow amount of a coolant circulating a coolant circulating path of the fuel cell system once for a time period, based on a target inflowing amount of coolant.

According to an embodiment, the method further includes operating the fuel cell stack, when the start sequence is terminated.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a fuel cell system, according to an embodiment of the present disclosure,

FIG. 2 is a view illustrating the structure to control a fuel cell system, according to an embodiment of the present disclosure;

FIG. 3 is a view illustrating the configuration of a coolant control valve, according to an embodiment of the present disclosure;

FIG. 4 is a view illustrating a control block diagram of a fuel cell system, according to an embodiment of the present disclosure;

FIG. 5A is a view illustrating a connection structure of a coolant control valve, according to an embodiment of the present disclosure;

FIG. 5B is a view illustrating a coolant flow depending on a connection structure of the coolant control valve of FIG. 5A;

FIG. 6A is a view illustrating a connection structure of a coolant control valve, according to an embodiment of the present disclosure;

FIG. 6B illustrating a coolant flow depending on a connection structure of the coolant control valve of FIG. 6A;

FIG. 7 is a flowchart illustrating the operation flow for a method for start control in a fuel cell system, according to an embodiment of the present disclosure; and

FIG. 8 is a view illustrating an operation flow of a start sequence, according to an embodiment of the present disclosure.

### DETAILED DESCRIPTION

Hereinafter, some embodiments of the present disclosure will be described in detail with reference to the accompanying drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In addition, in the following description of components according to an embodiment of the present disclosure, the terms ‘first’, ‘second’, ‘A’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

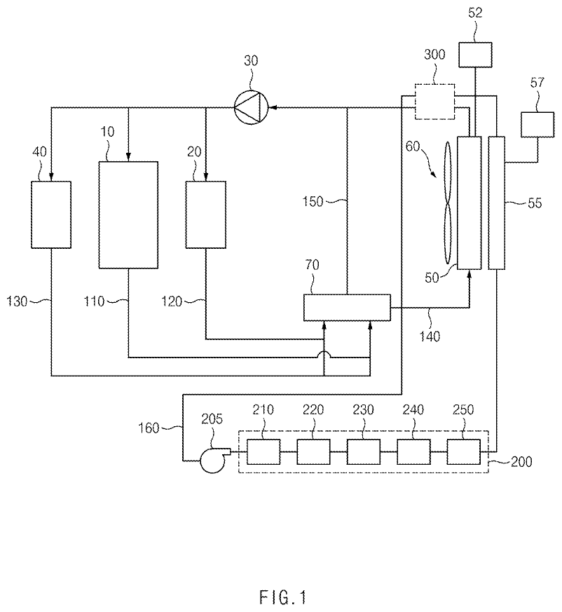

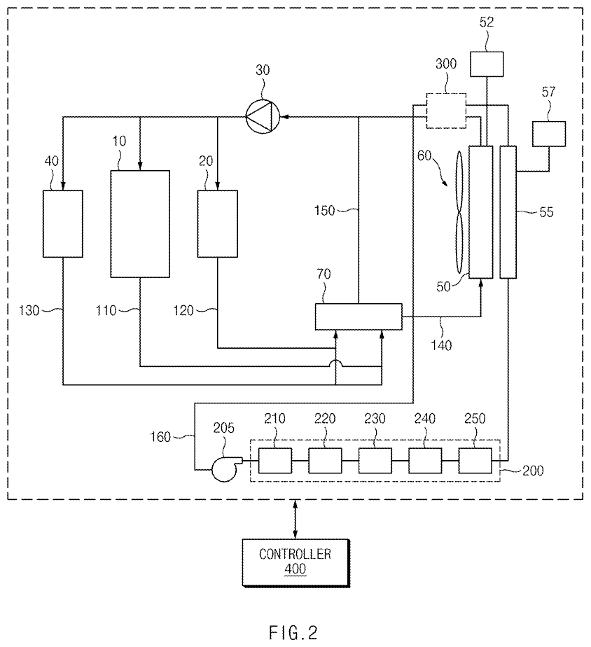

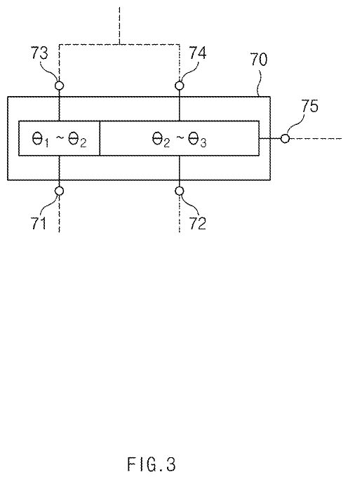

FIG. 1 is a view illustrating a fuel cell system, according to an embodiment of the present disclosure, FIG. 2 is a view illustrating the structure to control a fuel cell system, according to an embodiment of the present disclosure, and FIG. 3 is a view illustrating the configuration of a coolant control valve, according to an embodiment of the present disclosure.

Referring to FIG. 1, a fuel cell system for a vehicle may include a first cooling line allowing the circulation of a first coolant passing through the fuel cell stack 10 of the vehicle and a second cooling line 160 allowing the circulation of a second coolant passing through a power electronic part According to an embodiment, the fuel cell system may further include a heat exchanger 300 to mutually exchange heat between the first coolant and the second coolant.

The fuel cell system may include a plurality of fluid passages (for example, a first fluid passage 110 to a fifth fluid passage 150) forming the first cooling line. The first coolant may be cooled down and heated while being circulated through the first fluid passage 110 to the fifth fluid passage 150.

A fuel cell stack 10, a cathode oxygen depletion (COD) heater 20, a first pump 30, a coolant ion filter (CIF) 40, and a first radiator 50 may be configured to be provided on the first fluid passage 110 to the fifth fluid passage 150 for circulating the first coolant.

The fuel cell stack 10 (or may be referred to as a ‘fuel cell’) may be formed in a structure for generating electricity through an oxidation-reduction reaction between fuel (e.g., hydrogen) and an oxidizing agent (e.g., air). For example, the fuel cell stack 10 may include a membrane electrode assembly (MEA) having catalyst electrode layers attached to opposite sides of an electrolyte membrane for transferring hydrogen ions, a gas diffusion layer (GDL) to uniformly distribute reaction gases and transfer the generated electrical energy, a gasket and clamping mechanism to maintain airtightness and proper clamping pressure of reaction gases and cooling water, and a bipolar plate to transfer the reaction gases and the cooling water.

In the fuel cell stack 10, the hydrogen serving as fuel and the air (oxygen) serving as the oxidizing agent may be supplied to the anode and the cathode of the MEA through a fluid passage of the bipolar plate. For example, the hydrogen may be supplied to the anode and the air may be supplied to the cathode. The hydrogen, which is supplied to the anode, is decomposed into a proton and an electron through catalysts provided at opposite sides of an electrolyte film. Among them, only a hydrogen ion selectively passes through the electrolyte film, which is a cation exchange membrane, and is transmitted to the cathode while the electron is transmitted to the cathode through a gas diffusion layer and the bipolar plate. In the cathode, the hydrogen ions supplied through the electrolyte membrane and the electrons received through the bipolar plate meet oxygen of the air supplied to the cathode through an air supply device, thereby generating water. In this case, the electrons may flow through an external conductive line due to the transfer of the hydrogen ions, and the flow of the electrons may generate a current.

When the electrical conductivity of the first coolant is increased due to the corrosion or the exudation of the system, electricity flows to the first coolant, such that the fuel cell stack 10 may be shorted or a current may flow toward the first coolant. Accordingly, the first coolant should be maintained with a lower electrical conductivity. To this end, the coolant ion filter 40 may filter an ion of the first coolant. The coolant ion filter 40 may be set to remove an ion from the first coolant to maintain the electrical conductivity of the first coolant to be at a specific level or less.

The first radiator 50 may be set to cool the first coolant moving along the plurality of fluid passages, and a cooling fan 60 may be set to blow external air to the first radiator 50. The first radiator 50 may be formed in various structures to cool the first coolant, and the present disclosure is not limited by the type and the structure of the first radiator 50. The first radiator 50 may be connected to a reservoir 52 to store the first coolant.

The fluid passage to move the first coolant may include the first fluid passage 110 to pass through the fuel cell stack 10, the second fluid passage 120 to pass through the COD heater 20, and the third fluid passage 130 to pass through the coolant ion filter 40. Alternatively, the fluid passage to move the first coolant may further include the fourth fluid passage 140 to pass the first radiator 50 such that the first coolant heated by the fuel cell stack is cooled, and the fifth fluid passage 150 to pass through the first radiator 50 by by-passing the first radiator 50.

In addition, the fuel cell system may further include a coolant control valve 70 to switch a moving path of the first coolant through the first to fifth fluid passages 110 to 150. For example, the coolant control valve 70 may be configured in the form of an integrated coolant temperature control valve (ICTV) in which a first valve (for example, a coolant temperature control valve (CTV) to switch the flowing path of the first coolant flowing into the first pump 30 is integrated with a second valve (for example, a coolant bypass valve (CBV) to switch the flowing path of the first coolant pumped by the first pump 30. In this case, the first pump 30 may be a coolant supply pump (CSP).

The coolant control valve 70 may include a plurality of ports connected to the first to fifth fluid passages 110 to 150, and the valve opening state of each valve may be controlled by a controller 400.

Referring to FIG. 2, the controller 400 may be connected to components of the fuel cell stack to control the overall functions of the fuel cell system. The controller 400 may be a hardware device, such as a processor or a central processing unit (CPU), or a program implemented by the processor. For example, the controller 400 may be an upper controller. According to an exemplary embodiment of the present disclosure, the controller 400 may include a processor (e.g., computer, microprocessor, CPU, ASIC, circuitry, logic circuits, etc.) and an associated non-transitory memory storing software instructions which, when executed by the processor, provides the functionalities of the controller 400 as described here. Herein, the memory and the processor may be implemented as separate semiconductor circuits. Alternatively, the memory and the processor may be implemented as a single integrated semiconductor circuit. The processor may embody one or more processor(s).

The controller 400 may transmit or receive a signal to or from operating units of the fuel cell stack 10, the COD heater 20, the first pump 30, the coolant ion filter 40, the first radiator 50, and the cooling fan 60, may determine a control amount of each operating unit, and may manage the operating state of each operating unit.

The controller 400 may transmit or receive a signal to or from operating units of the fuel cell stack 10, the COD heater 20, the first pump 30, the coolant ion filter 40, the first radiator 50, and the cooling fan 60, may determine a control amount of each operating unit, and may manage the operating state of each operating unit. The controller 400 may determine target cooling performance of the fuel cell stack 10 for thermal management control when the fuel cell system is turned on, and may determine whether the target cooling performance of the fuel cell stack 10 is satisfied while operating each operating unit during the thermal management control operation.

The controller 400 may determine revolutions per minute (RPM) of the first pump 30 and an RPM of the cooling fan 60, based on target cooling performance of the fuel cell stack 10 determined, when the target cooling performance of the fuel cell stack 10 is determined for thermal management control.

In addition, the controller 400 may determine a valve opening amount of each port provided at the coolant control valve 70, based on the temperature of first coolant. The controller 400 may determine the flow rate of the first coolant, based on the RPM of the cooling fan 60, the temperature of the first coolant in an inlet and an outlet of the fuel cell stack 10, and the temperature of the first coolant in the outlet of the first radiator 50, and may determine the opening amount of the coolant control valve 70 based on the flow rate of the first coolant determined. In this case, the controller 400 may determine the flow rate of the first coolant flowing along each fluid passage, based on the temperature of the first coolant measured by the temperature sensor (not illustrated) provided on the fourth to fifth fluid passages 110 to 150 illustrated in FIG. 1. For example, the temperature sensor may measure the temperature of the first coolant in the inlet and the outlet of the fuel cell stack 10, the temperature of the first coolant in the outlet of the first radiator 50, and the temperature of the first coolant in the COD heater 20.

The controller 400 may control an inflowing flow rate of the first coolant to be lower than a preset flow rate, when the measured temperature of the first coolant circulated along a specific fluid passage is lower than a preset target temperature. As described above, when the measured temperature of the first coolant is lower, the inflowing flow rate of the first coolant inflowing into the fuel cell stack 10 is controlled to be lower, thereby minimizing the thermal impact and the degradation in performance due to the difference between the temperature of the first coolant staged at the side of the fuel cell stack 10 and the temperature of the first coolant inflowing into the fuel cell stack 10.

Referring to FIG. 3, the coolant control valve 70 may be a 5-way valve. For example, the coolant control valve 70 may include a first port 71 and a second port 72 to allow inflowing of the first coolant, and a third port 73, a fourth port 74, and a fifth port 75 to drain the first coolant inflowing through the first port 71 or the second port 72. Meanwhile, the first port 71 and the third port 73 may be adjusted in the opening amount of the valve in the range of a first value 61 to a second value 82. Meanwhile, the second port 72, the fourth port 74, and the fifth port 75 may be adjusted in the opening amount of the valve in the range of a first value 61 to a second value 82.

The first port 71 may be connected to the second fluid passage 120 to pass through the COD heater 20 and the third fluid passage 130 to pass through the coolant ion filter 40, such that the first coolant inflow into the first port 71 after passing through the second fluid passage 120 and the third fluid passage 130 when the first port 71 is open.

The second port 72 may be connected to the first fluid passage 110 to pass through the fuel cell stack 10 and the third fluid passage 130 to pass through the coolant ion filter 40, such that the first coolant inflow into the second port 72 after passing through the first fluid passage 110 and the third fluid passage 130 when the second port 72 is open. In this case, the first coolant passing through the coolant ion filter 40 may inflow into the first port 71 or the second port 72 depending on the opening/closing state of the first port 71 and the second port 72.

The third port 73 and the fourth port 74 are connected to the fifth fluid passage 150 to allow the first coolant to flow into an inlet of the first pump 30 without passing through the first radiator 50. For example, the third port 73 may be open together with the first port 71 when the first port 71 is opened, to drain the first coolant, which flows through the first port 71, through the fifth fluid passage 150. The fourth port 74 may be open when the second port 72 is open, to drain a portion or an entire portion of the first coolant introduced through the second port 72 through the fifth fluid passage 150.

The fifth port 75 may be connected to the fourth fluid passage 140 to pass through the first radiator 50 to drain the first coolant to the fourth fluid passage 140 when the fifth port 75 is open. The fourth port 75 may be open when the second port 72 is open, to drain a portion or an entire portion of the first coolant inflowing through the second port 72 through the fifth fluid passage 140.

The first coolant drained through the fifth port 75 may flow along the fourth fluid passage 140, may be cooled through the first radiator 50, and may flow in the first pump 30.

The opening and the closing of the first to fifth ports 71 to 75 of the coolant control valve 70 may be controlled by the controller 400. In other words, the controller 400 may determine the flowing path of the first coolant using the first to fifth fluid passages 110 to 150 illustrated in FIG. 1, and may control the opening state and the closing state of a valve at each port provided in the coolant control valve 70 along the flowing path of the first coolant, which is determined.

The coolant control valve 70 may switch the flowing path of the first coolant circulating the fuel cell system by opening valves of some ports of the first to fifth ports 71 to 75 in response to the control signal from the controller 400. In this case, the first coolant may be cooled or heated while circulating along some fluid passages of the first fluid passage 110, the second fluid passage 120, the third fluid passage 130, the fourth fluid passage 140, and the fifth fluid passage 150.

Meanwhile, the second cooling line 160 may be formed to pass through a power electronic part 200 of the vehicle, and the second coolant may be circulated along the second cooling line 160. In this case, the power electronic part 200 of the vehicle may be understood as a part used as an energy source of the power for the vehicle, and the present disclosure is not limited by the type and the number of the power electronic parts 200.

For example, the power electronic part 200 may include at least one of a bi-directional high voltage DC-DC converter 210 interposed between the fuel cell stack 10 and a high-voltage battery (not illustrated) of the vehicle, a blower pump control unit (BPCU) 220 to control a blower (not illustrated) to supply external air for operating the fuel cell stack 10, a low-voltage DC-DC converter 230 to convert a DC high voltage received from the high-voltage battery into a DC low voltage, an air compressor (ACP) 240 to compress air supplied to the fuel cell stack 10, and an air cooler 250. Although not illustrated in FIG. 1, the power electronic part 200 may further include a DC-DC buck/boost converter.

A second pump 205 may be disposed on the second cooling line 160 to force the second coolant to flow. The second pump 205 may include a pumping device to pump the second coolant, but the present disclosure is not limited in the type and the characteristic of the second pump 205.

A second radiator 55 may be provided on the second cooling line 160 to cool the second coolant. The second radiator 55 may be formed in various structures to cool the second coolant, but the present disclosure is not limited in the type and the structure of the second radiator 55. The second radiator 55 may be connected to a second reservoir 57 to store the second coolant.

According to an embodiment, the first radiator 50 and the second radiator 55 may be configured to simultaneously be cooled by one cooling fan 60 as illustrated in FIG. 1. For example, the first radiator 50 and the second radiator 55 may be disposed in parallel to each other, and the cooling fan 60 may be set to blow external air to the first radiator 50 and the second radiator 55. As the first radiator 50 and the second radiator 55 are simultaneously cooled by one cooling fan 60, the structure of the fuel cell system may be simplified, or the degree of freedom in design, the utilization of a space may be improved, and power consumption to cool the first radiator 50 and the second radiator 55 may be minimized. Alternatively, the first cooling fan to cool the first radiator 50 and the second cooling fan to cool the second radiator 55 may be individually disposed. In this case, when the fuel cell system controls the RPM of the first cooling fan, a parameter related to a thermal load of the power electronic part 200 may be excluded.

The heat exchanger 300 may be set to mutually exchange heat between the first coolant and the second coolant. When the heat exchanger 300 is provided, the first cooling lines 110 to 150 and the second cooling line 160 may constitute a thermal management system (TMS) line allowing the first coolant and the second coolant to flow while performing heat exchanging. In this case, the first coolant or the second coolant may be used as a cooling medium or a heat medium on the TMS line. For example, since the temperature of the second coolant for cooling the power electronic part 200 is lower than the temperature of the first coolant for cooling the fuel cell stack 10, the fuel cell system may reduce the temperature of the first coolant without increasing the capacity of the first radiator 50 and the cooling fan 60, improve the cooling efficiency of the fuel cell stack 10, and improve safety and reliability, as the first coolant and the second coolant mutually exchange heat between the first coolant and the second coolant.

According to an embodiment, the heat exchanger 300 may be connected to the first cooling line between the outlet of the first radiator 50 and the fuel cell stack 10, and the second cooling line 160 may connect the outlet of the second radiator 55 to the power electronic part 200 such that the second cooling line 160 passes through the heat exchanger 300. For example, the first coolant may flow along the heat exchanger 300 connected to the first cooling line, and the second cooling line 160 may pass through an inner part of the heat exchanger 300 to be exposed to the first coolant (for example, for the first coolant to flow along the circumference of the second cooling line 160).

As described above, the fuel cell system may lower the temperature of the first coolant introduced into the fuel cell stack 10 as the heat is mutually exchanged between the first coolant and the second coolant. The first temperature of the first coolant passing through the first radiator 50 may be formed to be higher than the second temperature of the second coolant passing through the second radiator 55, and the third temperature of the first coolant passing through the heat exchange 300 may be formed to be lower than the first temperature. For example, the first temperature of the first coolant may be formed to be higher than the second temperature of the second coolant by 10° C., and the third temperature of the first coolant (heat-exchanged with the second coolant) passing through the heat exchanger 300 may be formed to be lower than the first temperature by 1° C. Although the heat exchanger 300 is disposed separately from the first radiator 50, the heat exchanger 300 may be directly connected to the first radiator 50 according to an embodiment.

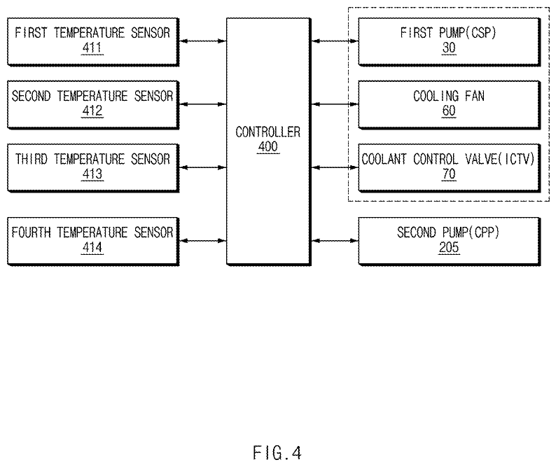

FIG. 4 is a view illustrating a control block diagram of a fuel cell system, according to an embodiment of the present disclosure. The control block diagram illustrated in FIG. 4 illustrates a control structure for start control in a fuel cell system.

Referring to FIG. 4, the controller 400 operates the fuel cell system by executing the start sequence previously defined when the fuel cell system is turned on. In this case, the controller 400 may determine whether to perform cold start or normal start, depending on an external temperature and the temperature of a coolant at an inlet of the fuel cell stack 10.

Accordingly, the fuel cell system may further include a plurality of temperature sensors. For example, the fuel cell system may include a first temperature sensor 411 to measure the external temperature of the vehicle and a second temperature sensor 412 to measure the temperature of the coolant at the inlet of the fuel cell stack 10. In addition, the fuel cell system may further include a third temperature sensor 413 to measure the temperature of a coolant passing through the coolant ion filter 40 and a fourth temperature sensor 414 to measure the temperature of the coolant inflowing into the coolant control valve 70. For example, the third temperature sensor 413 may be provided on a fluid passage at the inlet of the coolant ion filter 40, and the fourth temperature sensor 414 may be provided on a fluid passage between an outlet of the fuel cell stack 10 and the second port of the coolant control valve 70. In this case, the second temperature sensor 412 and the third temperature sensor 413 may be realized in the form of one temperature sensor. In this case, the temperature sensor to measure the temperatures at the inlet of the fuel cell stack 10 and/or the coolant ion filter 40 may be provided on the fluid passage to connect the inlet of the fuel cell stack 10 to the coolant ion filter 40.

The controller 400 receives information on an external temperature measured by the first temperature sensor 411 and the temperature of a coolant at the inlet of the fuel cell stack 10, which is measured by the second temperature sensor 412, when the fuel cell system is turned on.

In this case, the controller 400 may perform the start sequence for the cold start, when the external temperature received from the first temperature sensor 411 is equal to or less than the first set temperature (T1) preset, and when the temperature of the coolant at the inlet of the fuel cell stack 10, which is received from the second temperature sensor 412, is equal to or less than a second set temperature (T2), which is preset.

Meanwhile, the controller 400 may perform the start sequence for the normal start, when the external temperature received from the first temperature sensor 411 is equal to or less than the first set temperature (T1) preset, and when the temperature of the coolant at the inlet of the fuel cell stack 10, which is received from the second temperature sensor 412, is equal to or less than a second set temperature (T2), which is preset. However, in the following description about an embodiment of the present disclosure, the details of the start sequence will be omitted.

The controller 400 may control the first pump (CSP) 30 and the second pump (CPP) 205, the cooling fan (C/FAN) 60, and the coolant control valve (ICTV) 70, depending on the start sequence defined previously, in normal start.

First, the controller 400 may set an opening amount of a valve of each port to a specific angle through the coolant control valve (ICTV) 70, as the first operation of the start sequence. In this case, while the start sequence is performed, the controller 400 allows the first coolant to flow in the fuel cell stack 10, and may control the valve opening amount of the coolant control valve (ICPV) 70 such that the first coolant flowing to the first radiator 50 is by-passed to prevent the first coolant from being cooled. In this case, the controller 400 may prevent the first coolant from flowing in the COD heater 20.

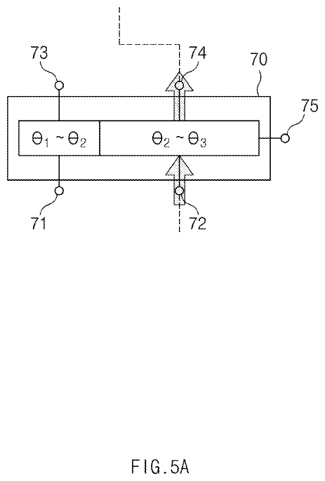

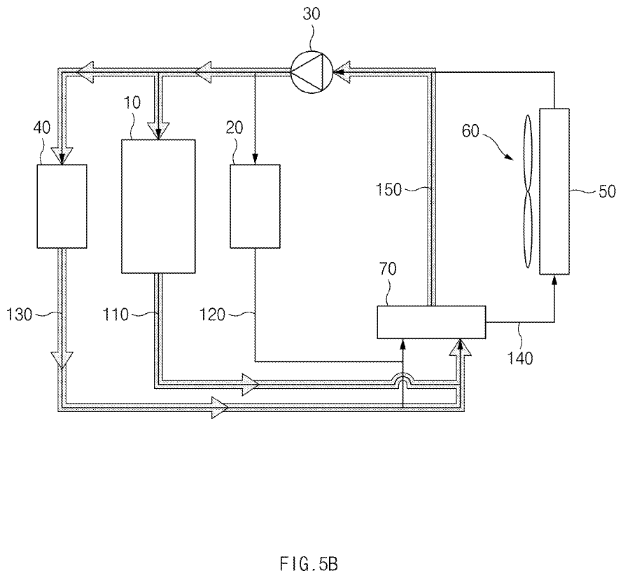

Accordingly, the connection structure of the coolant control valve 70 and the flow of the coolant based on the start sequence will be described with reference to FIGS. 5A and 5B.

FIG. 5A is a view illustrating a connection structure of a coolant control valve in start, according to an embodiment of the present disclosure, and FIG. 5B is a view illustrating a coolant flow depending on a connection structure of the coolant control valve of FIG. 5A.

Referring to FIG. 5A, the controller 400 may not ensure a start ability through heat of the fuel cell stack 10 in normal start, such that an additional heating loop passing through the COD heater 20 is not formed. Accordingly, the controller 400 opens valves of the second port 72 and the fourth port 74 of the coolant control valve 70 connected to the first fluid passage 110 passing through the fuel cell stack 10 and the third fluid passage passing through the coolant ion filter 40, such that the first coolant is supplied to the fuel cell stack 10.

In addition, the controller 400 may close the valve of the fifth port 75 of the coolant control valve 70 connected to the fourth fluid passage 140 for passing through the first radiator 50 to bypass the first coolant flowing into the first radiator 50. Accordingly, the first coolant passing through the fuel cell stack 10 and the coolant ion filter 40 may flow into the second port 72 of the coolant control valve 70 to flow along the fifth fluid passage 150 which is a by-pass fluid passage through the fourth port 74.

In addition, to prevent the first coolant to flowing in the COD heater 20, the controller 400 closes valves of the first port 71 and the third port 73 of the coolant control valve 70 connected the second fluid passage 120 passing through the COD heater 20 in start.

As described above, the coolant control valve (ICTV) 70 closes the first port 71, the third port 73, and the fifth port 75 to prevent the first coolant from flowing into the COD heater 20 and the first radiator 50, and opens the second port 72 and the fourth port 74 to allow the first coolant to flow in the fuel cell stack 10 and the coolant ion filter 40. Accordingly, a loop may be formed such that the first coolant is circulated along the first fluid passage 110, the third fluid passage 130, and the fifth fluid passage 150.

In this case, the flow of the first coolant resulting from the control of the coolant control valve 70 is illustrated in FIG. 5B. Referring to FIG. 5B, the fuel cell system may ensure the start ability through the heat of the fuel cell stack 10, as the first coolant is circulated along the first fluid passage 110, the third fluid passage 130, and the fifth fluid passage 150.

Since the fifth port 75 of the coolant control valve 70 is closed during start, the first coolant may flow into the fuel cell stack 10 through the first pump 30 through the fifth fluid passage 150 by by-passing the first radiator 50.

In addition, as the first coolant is circulated along the third fluid passage 130 while circulating the first fluid passage 110 and the fifth fluid passage 150, the electrical conductivity of the first coolant may be maintained to be at a specific level or less through filtering (removing an ion included in a coolant) by the coolant ion filter 40 provided on the third fluid passage 130.

When the first coolant starts flowing along the fluid passage illustrated in FIG. 5B, the controller 400 sets the RPM of the first pump (CSP) 30 and the second pump (CPP) to minimum set values (MIN), as a second operation of the start sequence. In this case, the second operation may be performed to protect the power electronic part during the start sequence.

The controller 400 may switch, as a third operation of the start sequence, the control mode of the coolant control valve (ICTV) 70 to an automatic control mode, when a coolant temperature (T_{CIF}) sensed from the third temperature sensor 413 to measure the coolant temperature of the coolant ion filter 40 and a coolant temperature (T_{ICTV}) sensed from a fourth temperature sensor 414 to measure a coolant temperature of the coolant control valve (ICTV) 70 satisfy a reference condition. For example, the third temperature sensor 413 may be provided on a fluid passage at the inlet of the coolant ion filter 40, and the fourth temperature sensor 414 may be provided on a fluid passage between an outlet of the fuel cell stack 10 and the second port 72 of the coolant control valve 70.

In this case, the automatic control mode of the coolant control valve (ICTV) 70 refers to a mode for the controller 400 to automatically adjust a valve opening amount of the coolant control valve (ICTV) 70, based on the coolant temperature (T_{ICTV}) sensed by the fourth temperature sensor 414. In this case, the controller 400 may automatically adjust the valve opening amount of the coolant control valve 70 such that the coolant temperature (T_{ICTV}) sensed by the fourth temperature sensor 414 is maintained to be in a target temperature range.

The reference condition to perform the third operation may correspond to a condition in which the coolant temperature (T_{CIF}) of the coolant ion filter 40 sensed by the third temperature sensor 413 and the coolant temperature (T_{ICTV}) of the coolant control valve 70, which is sensed by the fourth temperature sensor 414, are equal to or greater than the temperature of ambient air or the coolant temperature at the inlet of the fuel cell stack 10.

The controller 400 may iterate the first operation and the second operation of the start sequence, when the coolant temperature (T_{CIF}) of the coolant ion filter 40 sensed by the third temperature sensor 413 and the coolant temperature (T_{ICTV}) of the coolant control valve 70, which is sensed by the fourth temperature sensor 414, fail to satisfy the reference condition.

When the control mode of the coolant control valve 70 is switched to the automatic control mode through the third operation of the start sequence, the controller 400 allows the cooling fan 60 to enter into an operating allowing mode, as a fourth operation of the start sequence. In addition, the controller 400 may set the RPM of the first pump (CSP) 10 to a specific value (w), as a fifth operation of the start sequence. In this case, the specific value (w) refers to an RPM to drain a flow amount of a coolant circulating the fuel cell system once for a time period of ‘t’, based on a target inflowing amount of coolant. In this case, the size of the specific value (w) may be variously set depending on the specification of the first pump 30.

The controller 400 operates the fuel cell stack 10, when the start of the fuel cell system has been finished. In this case, the controller 400 may control a valve opening amount of the coolant control valve (ICTV) 70 such that the first coolant flows into the first radiator 50, thereby cooling down the first coolant heated by the fuel cell stack 10.

Accordingly, the connection structure of the coolant control valve 70 and the flow of the coolant in operation of the fuel cell stack 10 will be described with reference to FIGS. 5A and 5B.

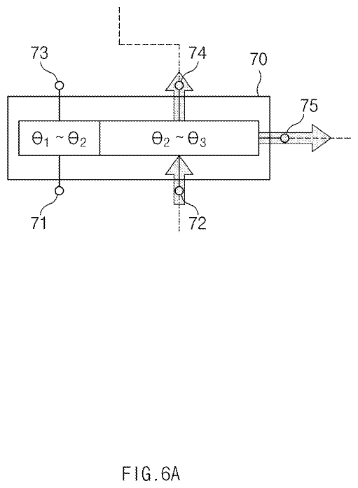

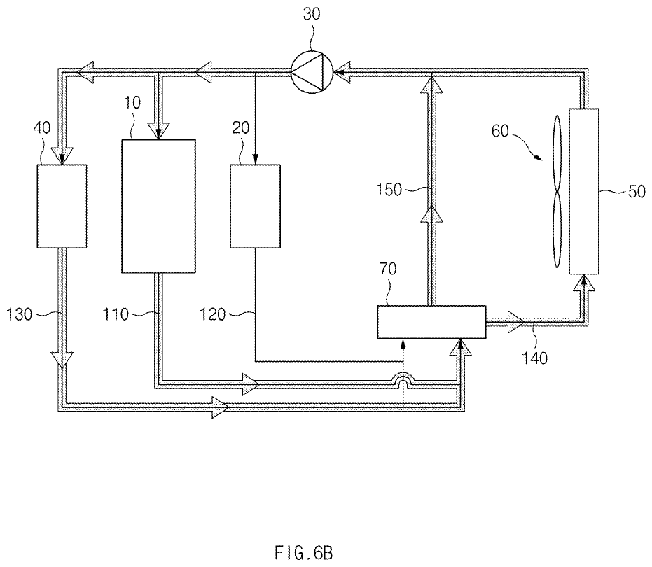

FIG. 6A is a view illustrating a connection structure of a coolant control valve in operation, according to an embodiment of the present disclosure, and FIG. 6B illustrating a coolant flow depending on a connection structure of the coolant control valve of FIG. 6A.

Referring to FIGS. 6A and 6B, the controller 400 opens values of ports, that is, the second port 72 and the fifth port 75, which are connected to the fuel cell stack 10 and the first radiators 50, of the coolant control valve 70. In this case, the controller 400 may open the valve of the fourth port 74 connected to the fifth fluid passage which is a by-pass fluid passage. In this case, a portion of the first coolant may pass through the first radiator 50 along the fourth fluid passage 140, and a remaining portion of the first coolant may flow along the fifth fluid passage 150.

Meanwhile, the coolant control valve 70 may close the valves of the first port 71 and the third port 73 connected to the second fluid passage 120 to prevent the first coolant from flowing into the COD heater 20. In this case, as illustrated in FIG. 6B, a cooling loop may be formed to allow the first coolant to circulate along the first fluid passage 110, the third fluid passage 130, the fourth fluid passage 140, and the fifth fluid passage 150.

Hereinafter, the operation flow for the start control in the fuel cell system having the above configuration will be described in more detail according to the present disclosure.

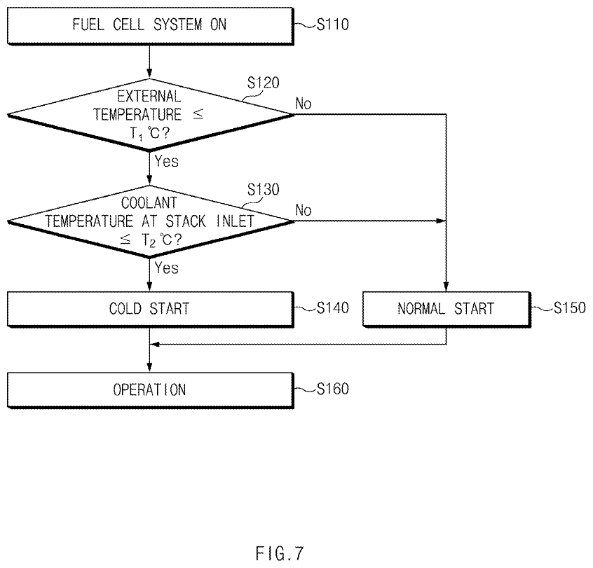

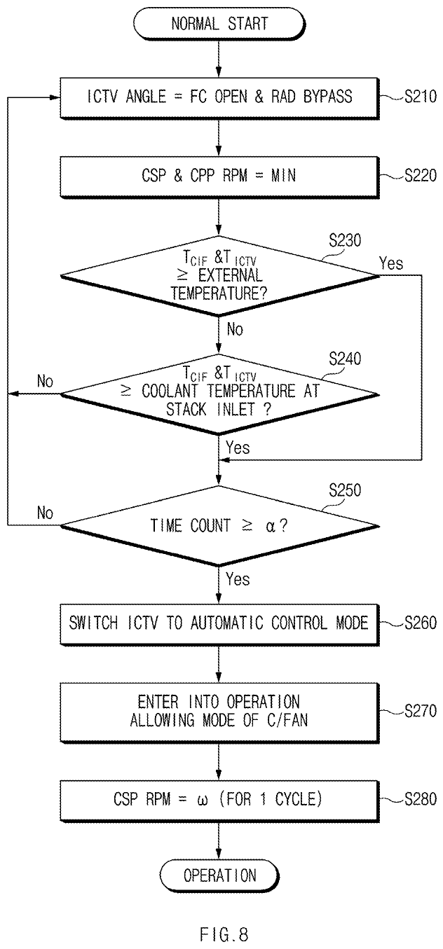

FIG. 7 is a flowchart illustrating the operation flow for a method for start control in a fuel cell system, according to an embodiment of the present disclosure, and FIG. 8 is a view illustrating an operation flow of a start sequence, according to an embodiment of the present disclosure.

First, referring to FIG. 7, the fuel cell system determines temperature received from the first temperature sensor 411 to measure the temperature of ambient air and the second temperature sensor 412 to measure the coolant temperature at the inlet of the fuel cell stack 10, when the fuel cell system is turned on (S110). In this case, when the determined temperature of the ambient air is equal to or less than the first temperature (T1) (S120) and when the coolant temperature at the inlet of the fuel cell stack 10 is equal to or less than the second temperature (T2) which is preset (S130), the fuel cell system determines the condition of the cold start as being satisfied to perform cold start (S140) and then operates the fuel cell stack 10 (S160).

In this case, when the determined temperature of the ambient air exceeds the first temperature (T1) in S120 and when the coolant temperature at the inlet of the fuel cell stack 10 exceeds the second temperature (T2) which is preset, the fuel cell system determines the condition of the normal start as being satisfied to perform normal start (S150) and then operates the fuel cell stack 10 (S160).

The fuel cell system may perform the start sequence of FIG. 8 in the normal start in S150.

Referring to FIG. 8, while the start sequence is performed, the fuel cell system allows the first coolant to flow in the fuel cell stack 10, and may control the valve opening amount of the coolant control valve (ICPV) 70 such that the first coolant flowing to the first radiator 50 is by-passed to prevent the first coolant from being cooled (S210).

In this case, the fuel cell system sets the RPMs of the first pump (CSP) 30 and the second pump (CPP) 205 to minimum set values (MIN) (S220).

Thereafter, the fuel cell system may switch the control mode of the coolant control valve 70 to the automatic control mode, when the coolant temperature (T_{CIF}) of the coolant ion filter 40 sensed by the third temperature sensor 413 and the coolant temperature (T_{ICTV}) of the coolant control valve 70, which is sensed by the fourth temperature sensor 414, satisfy the reference condition. For example, the third temperature sensor 413 may be provided on a fluid passage at the inlet of the coolant ion filter 40, and the fourth temperature sensor 414 may be provided on a fluid passage between an outlet of the fuel cell stack 10 and the second port 72 of the coolant control valve 70.

In this case, the automatic control mode of the coolant control valve (ICTV) 70 refers to a mode for the controller 400 to automatically adjust a valve opening amount of the coolant control valve (ICTV) 70, based on the coolant temperature (Tic-v) sensed by the fourth temperature sensor 414. In this case, the controller 400 may automatically adjust the valve opening amount of the coolant control valve 70 such that the coolant temperature (T_{ICTV}) of the coolant control valve 70 sensed by the fourth temperature sensor 414 is maintained to be in a target temperature range.

Accordingly, the fuel cell system may maintain S210 and S220 when the coolant temperature (T_{CIF}) of the coolant ion filter 40 sensed by the third temperature sensor 413 and the coolant temperature (T_{ICTV}) of the coolant control valve 70, which is sensed by the fourth temperature sensor 414, are less than the temperature of ambient air or the coolant temperature at the inlet of the fuel cell stack 10.

Accordingly, the fuel cell system may determine that the reference condition is satisfied when the coolant temperature (T_{CIF}) of the coolant ion filter 40 sensed by the third temperature sensor 413 and the coolant temperature (T_{ICTV}) of the coolant control valve 70, which is sensed by the fourth temperature sensor 414, are maintained to be equal to or greater than the temperature of ambient air (S230), or maintained to be equal to or greater than the coolant temperature at the inlet of the fuel cell stack 10 (S240) for a specific period of time (a) (S250).

Accordingly, the fuel cell system switches the control mode of the coolant control valve 70 to the automatic control mode when the reference condition is satisfied in S230 to S250 (S260).

Thereafter, the fuel cell system allows the cooling fan 60 to enter into the operating allowing mode (S270), and sets the RPM of the first pump (CSP) 30 to a specific value (ω) (S280). In this case, the specific value (ω) refers to an RPM to drain a flow amount of a coolant circulating the fuel cell system one time for a time period of ‘t’, based on a target inflowing amount of coolant. In this case, the size of the specific value (ω) may be variously set depending on the specification of the first pump 30.

The controller 400 operates the fuel cell stack 10, when the start of the fuel cell system has been finished.

As described above, according to an embodiment, thermal management components, such as a coolant pump and an integrated coolant control valve, may be rapidly and easily controlled in starting a fuel cell stack, and a method for start control therein.

The above description is merely an example of the technical idea of the present disclosure, and various modifications and modifications may be made by one skilled in the art without departing from the essential characteristic of the invention.

Accordingly, embodiments of the present disclosure are intended not to limit but to explain the technical idea of the present disclosure, and the scope and spirit of the invention is not limited by the above embodiments. The scope of protection of the present disclosure should be construed by the attached claims, and all equivalents thereof should be construed as being included within the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A fuel cell system comprising:
a coolant control valve configured to switch a flowing path of a coolant passing through a fluid passage connected to a fuel cell stack; and
a controller configured to control a valve opening amount of the coolant control valve by performing a start sequence previously defined, when a condition for normal start of the fuel cell stack is satisfied,
wherein the coolant control valve is formed by integrating a first valve, which is to switch a flowing path of a coolant flowing into a first pump, with a second valve which is to switch a flowing path of a coolant pumped by the first pump.

2. The fuel cell system of claim 1, further comprising:
a first temperature sensor configured to measure a temperature of ambient air;
a second temperature sensor configured to measure a temperature of a coolant at an inlet of the fuel cell stack;
a third temperature sensor configured to measure a coolant temperature in an ion filter to filter an ion of the coolant passing through the fuel cell stack; and
a fourth temperature sensor configured to measure a coolant temperature of the coolant control valve.

3. The fuel cell system of claim 2, wherein the controller is configured to:
determine that the condition for the normal start of the fuel cell stack is satisfied, when the temperature of the ambient air, which is measured by the first temperature sensor, is equal to or greater than a first reference temperature, which is preset, or when the coolant temperature at the inlet of the fuel cell stack, which is measured by the second temperature sensor, is equal to or greater than a second reference temperature which is preset.

4. The fuel cell system of claim 2, wherein the start sequence includes:
a first operation for controlling the valve opening amount of the coolant control valve to open a valve connected to a fluid passage passing through the fuel cell stack and close a valve connected to a fluid passage passing through a radiator,
a second operation for setting, to a preset minimum value, a Revolution per Minute (RPM) of a second pump to supply a coolant to the first pump and the power electronic part,
a third operation for switching a control mode of the coolant control valve to an automatic control mode, when the coolant temperature of the coolant ion filter, which is measured by the third temperature sensor, and the coolant temperature of the coolant control valve, which is measured by the fourth temperature sensor, satisfy a preset condition,
a fourth operation for allowing a cooling fan to enter into an operating allowing mode, and
a fifth operation for setting an RPM of the first pump to a specific value (ω).

5. The fuel cell system of claim 4, wherein the coolant control valve includes:
a first port connected to a second fluid passage passing through a cathode oxygen depletion (COD) heater such that coolant passing through the second fluid passage flows in the first port;
a second port connected to a first fluid passage passing through the fuel cell stack such that coolant passing through the first fluid passage flows in the second port;
a third port for draining the coolant flowing in the first port through the second fluid passage connected to the first pump through a fifth fluid passage serving as a by-pass fluid passage of a radiator;
a fourth port for draining the coolant flowing in the second port through the first fluid passage connected to the first pump through the fifth fluid passage; and
a fifth port for draining the coolant flowing in the second port, through a fourth fluid passage passing through the radiator.

6. The fuel cell system of claim 5, wherein the coolant control valve is configured to:
close a valve of the fifth port connected to the fourth fluid passage to block the coolant flowing into the radiator, and open a valve of the fourth port connected to the fifth fluid passage serving as a by-pass fluid passage, when the first operation of the start sequence is performed.

7. The fuel cell system of claim 4, wherein the controller is configured to:
determine that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than the temperature of the ambient air even though a specific time is elapsed.

8. The fuel cell system of claim 4, wherein the controller is configured to:
determine that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than the coolant temperature at the inlet of the fuel cell stack, even though a specific time is elapsed.

9. The fuel cell system of claim 4, wherein the controller is configured to:
automatically adjust the valve opening amount of the coolant control valve such that the coolant temperature of the coolant control valve is maintained in a target temperature range, when the control mode of the coolant control valve is switched to the automatic control mode through the third operation.

10. The fuel cell system of claim 4, wherein the specific value (ω) refers to an RPM for draining a flow amount of a coolant circulating a coolant circulating path of the fuel cell system once for a time period, based on a target inflowing amount of coolant.

11. The fuel cell system of claim 1, wherein the controller is configured to:
operate the fuel cell stack, when the start sequence is terminated.

12. A method for start control in a fuel cell system, the method comprising:
performing a start sequence previously defined, when a condition for normal start of a fuel cell stack is satisfied;
controlling a valve opening amount of a coolant control valve to switch a flowing path of a coolant passing through a fluid passage connected to the fuel cell stack; and
switching, by the coolant control valve, a flowing path of a coolant, based on the control,
wherein the coolant control valve is formed by integrating a first valve to switch a flowing path of a coolant flowing into a first pump with a second valve to switch a flowing path of a coolant pumped by the first pump.

13. The method of claim 12, further comprising:
determining that the condition for the normal start of the fuel cell stack is satisfied, when temperature of ambient air, which is measured by a first temperature sensor, is equal to or greater than a first reference temperature, which is preset, or when a coolant temperature at the inlet of the fuel cell stack, which is measured by a second temperature sensor, is equal to or greater than a second reference temperature which is preset.

14. The method of claim 12, wherein the performing of the start sequence includes:
performing a first operation for controlling the valve opening amount of the coolant control valve to open a valve connected to a fluid passage passing through the fuel cell stack and close a valve connected to a fluid passage passing through a radiator;
performing a second operation for setting, to a preset minimum value, a Revolution per Minute (RPM) of a second pump to supply a coolant to the first pump and a power electronic part;
performing a third operation for switching a control mode of the coolant control valve to an automatic control mode, when a coolant temperature of an ion filter, which is measured by a third temperature sensor, and a coolant temperature of the coolant control valve, which is measured by a fourth temperature sensor, satisfy a preset condition;
performing a fourth operation for allowing a cooling fan to enter into an operating allowing mode; and
performing a fifth operation for setting an RPM of the first pump to a specific value (ω).

15. The method of claim 14, wherein the performing of the first operation includes:
closing a valve connected to a fluid passage passing through the radiator and opening a value connected to a by-pass fluid passage of the radiator.

16. The method of claim 14, wherein the performing of the third operation includes:
determining that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than the temperature of the ambient air even through a specific time is elapsed.

17. The method of claim 14, wherein the performing of the third operation includes:
determining that a reference condition for performing the third operation is satisfied, when the coolant temperature in the coolant ion filter, which is measured by the third temperature sensor, and the coolant temperature of the coolant control valve, which is measured by the fourth temperature sensor, are equal to or greater than a coolant temperature at an inlet of the fuel cell stack, even though a specific time is elapsed.

18. The method of claim 14, wherein the performing of the third operation includes:
automatically adjusting the valve opening amount of the coolant control valve such that the coolant temperature of the coolant control valve is maintained in a target temperature range, when a control mode of the coolant control valve is switched to an automatic control mode.

19. The method of claim 14, wherein the specific value (ω) refers to an RPM for draining a flow amount of a coolant circulating a coolant circulating path of the fuel cell system once for a time period, based on a target inflowing amount of coolant.

20. The method of claim 12, further comprising:
operating the fuel cell stack, when the start sequence is terminated.
